(19) United States
(12) Patent Application Publication
(10) Pub. No.: US 2025/0364637 A1
(43) Pub. Date: Nov. 27, 2025

(54) MULTILAYER PROTECTIVE ELEMENT FOR A BATTERY ASSEMBLY COMPRISING AT LEAST TWO BATTERY CELLS

(71) Applicant: Henkel AG & Co. KGaA, Duesseldorf (DE)

(72) Inventors: Keon Woo Lee, Duesseldorf (DE); Tobias Knecht, Muenster (DE); Roger Calixto de Araujo, Koeln (DE); Stefan Otte, Goettingen (DE); Nina Almstedt, Duesseldorf (DE)

(21) Appl. No.: 19/241,898

(22) Filed: Jun. 18, 2025

Related U.S. Application Data
(63) Continuation of application No. PCT/EP2023/084665, filed on Dec. 7, 2023.

(30) Foreign Application Priority Data
Dec. 22, 2022 (EP) 22216029.3

(51) Int. Cl. H01M 10/658; B32B 5/02; B32B 7/12; B32B 27/12; H01M 10/6555; H01M 50/242

(52) U.S. Cl. CPC H01M 10/658; B32B 5/022; B32B 7/12; B32B 27/12; H01M 10/6555; H01M 50/242; B32B 2307/304; B32B 2307/306; B32B 2307/7376; B32B 2457/10

(57) ABSTRACT

The invention relates to a multilayer protective element (1) for a battery assembly (100) comprising at least two battery cells (10), wherein the protective element (1) can be arranged between the battery cells (10) and wherein the protective element (1) comprises at least two heat resistant layers, wherein a first layer is formed as an elastic buffer layer (2) and comprises a an non-woven polymeric material and/or a non-woven ceramic material and a second layer is formed as a stiff heat insulating barrier layer (3) and comprises a ceramic material. The invention further relates to a battery assembly (100) comprising such a multilayer protective element (1), and to methods and uses of a multilayer protective element (1) in a battery assembly (100).

### FIELD OF THE INVENTION

The invention relates to a multilayer protective element for a battery assembly comprising at least two battery cells. The invention further relates to a battery assembly comprising such a multilayer protective element and to the use of a multilayer protective element in a battery assembly.

### BACKGROUND OF THE INVENTION

Nowadays, high-voltage batteries are used in numerous applications, especially in connection with electromobility. For this purpose, individual battery cells are assembled to form larger battery arrays. The individual battery cells, which are usually in the form of prismatic or pouch-shaped battery cells with two flat outer surfaces facing each other in parallel, are arranged close together in an outer housing and connected in series and/or in parallel. Depending on the number of battery cells used, battery assemblies with an energy capacity of between 5 and 200 kWh and an operating voltage of between 60 and 800 V can be provided in this way.

During operation, the battery cells can be subject to various reversible and non-reversible processes, which are already countered by various measures in the state of the art.

Thus, battery cells expand to a certain extent during each charging process, and contract again during the subsequent discharging process. This process is also known as “breathing” of the battery cell. In order to compensate for the associated dimensional changes, balancing elements are already used today, which are arranged between the individual battery cells. Such a balancing system is known, for example, from U.S. Pat. No. 10,840,494 B2. Additionally, over time, the breathing effects can be accumulated, leading to permanent expansion of the cell.

In addition to breathing, which all battery cells are subject to, thermal runaway can occur in individual battery cells under extreme conditions during operation. This is an uncontrolled reaction within a battery cell that can be accompanied by extreme heat and pressure development. The heat can quickly transfer to neighbouring battery cells and start a chain reaction, releasing energy explosively and causing the battery assembly to catch fire. For this reason, it is already known, for example from EP 3 661 744 B1 and WO 2008/136875 A1, to provide barriers made of fire protection materials between the individual battery cells to prevent thermal runaway from spreading to neighbouring battery cells. However, such barriers made of fire protection materials are not sufficiently capable of reacting to the dimensional changes of the battery cells described above. US 2022/0166086 A1 discloses a battery block including a plurality of battery cells stacked along a thickness of each of the plurality of battery cells with a separator interposed between the plurality of battery cells. . . . US 2022/0181715 A1 discloses a thermally insulating multilayer sheet including a compressible layer, and a thermal insulation layer.

### SUMMARY OF THE INVENTION

The object underlying the present invention is to provide an improved multilayer protective element for a battery assembly which can both compensate for dimensional changes in the individual battery cells in the course of charging and discharging cycles and at the same time provide very good protection against the propagation of heat in the course of thermal runaway of a battery cell. It is a further object of the invention to provide a battery assembly with such a protective element.

These objects are accomplished by a protective element with the features of the invention as well as by a battery assembly with the protective element as disclosed herein and a use of a protective element to the invention. Advantageous embodiments and further developments of the invention are the subject of the various embodiments disclosed and claimed herein.

In the following, the invention is explained in more detail by means of description of embodiments, examples and with reference to the accompanying drawings, in which:

### BRIEF DESCRIPTION OF THE DRAWINGS

FIG. 1: shows a schematic sectional view of an embodiment of a protective element according to the invention;

FIG. 2: shows an alternative embodiment of a protective element according to the invention in schematic sectional view;

FIG. 3: shows a battery assembly with a protective element according to the invention.

### DETAILED DESCRIPTION OF VARIOUS EMBODIMENTS

According to one embodiment, the invention is a multilayer protective element for a battery assembly comprising at least two battery cells, wherein the protective element can be arranged between the battery cells. The invention is characterized in that the protective element comprises at least two heat resistant layers, wherein a first layer is formed as an elastic buffer layer and comprises a non-woven polymeric material and/or a non-woven ceramic material and a second layer is formed as a stiff heat insulating barrier layer and comprises a ceramic material. The elastic buffer layer comprises preferably a non-woven polymeric fiber as non-woven polymeric material and/or a non-woven ceramic fiber as non-woven ceramic material. The adjective heat-resistant should be understood in this context to mean that the respective layer does not melt and/or oxidize when exposed to a temperature of up to 600° C. over a period of two minutes. According to the invention both layers, the elastic buffer layer and the stiff heat insulating barrier layer are heat resistant according to this understanding. Preferably, the meaning is that the respective layer does not melt and/or oxidize when exposed to a continuous temperature of 600° C. over a period of two minutes. The adjective stiff should be understood in this context to mean that the barrier layer is more rigid than the elastic buffer layer so that the barrier layer is not compressed or less compressed compared to the elastic buffer layer in the course of the dimensional changes of the battery cells.

In other words, due to its layered structure and the special materials used, the protective element according to the invention combines elastic as well as insulating and fire-retardant properties in one component and is therefore designed as a multifunctional protective element. The elastic buffer layer, which comprises a non-woven polymeric material and/or a non-woven ceramic material, preferably a non-woven polymeric fiber and/or a non-woven ceramic fiber, is capable of being compressed when the battery cells expand and of being recovered when the battery cells contract. The restoring forces occurring in the elastic material as a result of this compression cause this layer to move back to its original state when the battery cells contract. In this way, dimensional changes of the battery cells especially at the center of their flat outer surfaces can be dynamically compensated.

The heat insulating barrier layer comprises a ceramic material that has low thermal conductivity and good fire retardant properties. In this way, heat transfer from one battery cell to an adjacent battery cell can be substantially prevented or delayed.

The compressible properties of the protective element can also be utilized already during the assembly of a battery assembly comprising a plurality of individual battery cells. For example, when assembling a battery assembly, a stack of battery cells is fitted into an outer housing; the arrangement of a compressible protective element according to the invention between at least some of the battery cells allows the stack of battery cells to be somewhat compressed and thus optimally fitted into the outer housing.

In a simplest embodiment, the protective element comprises a buffer layer and a barrier layer. In principle, however, the protective element can also comprise several buffer layers and/or several barrier layers and/or other layers of a different design.

According to one embodiment of the invention, the polymeric material of the buffer layer is selected from a group comprising a non-woven fiber which is made of partially and fully oxidized polyacrylonitrile, silicate, silica, metal oxide, metal nitride, metal carbide, metal carbonate, mica, rock powder, glass fiber, and combinations of materials comprising one or more of these materials. These materials have good elastic properties in the non-woven state, i.e. they are compressible under the action of force and return to their initial state when the force is released.

According to another embodiment of the invention, the ceramic material of the buffer layer is selected from a group of materials comprising a nonwoven fiber which is made of silicate, silica, metal oxide, metal nitride, metal carbide, metal carbonate, mica, rock powder, glass fiber, and combinations of materials comprising one or more of these materials. It can be designed as a pad or a composite of ceramic material.

Preferably, the compression force of the buffer layer at 25% compression of this buffer layer is about 5 to 300 kPa, more preferably 5 to 200 kPa, and the compression set is preferably less than 10%, more preferably less than 5%, based on standard specification ASTM D1056 at a temperature of about 100° C. According to the invention especially the buffer layer is heat-resistant, which should be understood in this context to mean that the buffer layer does not melt and/or oxidize when exposed to a temperature of up to 600° C. over a period of two minutes. Preferably, the buffer layer does not melt and/or oxidize when exposed to a continuous temperature of 600° C. over a period of two minutes. In a preferred embodiment this buffer layer has heat insulating properties with a thermal conductivity of preferably less than 0.5 W/mK, particularly preferably less than 0.3 W/mK in a direction perpendicular to the surface area facing a battery cell.

According to another embodiment of the invention, the ceramic material of the barrier layer is selected from a group of materials comprising silicate, silica, metal oxide, metal nitride, metal carbide, metal carbonate, mica, rock powder, glass fiber, and combinations of materials comprising one or more of these materials. It can be designed as a pad or a composite of ceramic material. Preferably the ceramic material of the barrier layer is not a non-woven material, especially not a non-woven fiber.

The barrier layer preferably has a fire-retardancy of level V1 measured by the UL 94 Test for Flammability of Plastics, and a fire-retardancy of level V0 measured by the UL 94 Test for Flammability of Plastics is particularly preferred. The barrier layer preferably has heat insulating properties with a thermal conductivity of preferably less than 0.5 W/mK, particularly preferably less than 0.3 W/mK in a direction perpendicular to the surface area facing a battery cell.

According to one proposal of the invention, the buffer layer has a thickness of 0.1 to 10 mm. Preferably, the thickness of the buffer layer can be in a range between 3 and 5 mm.

According to a further suggestion of the invention, the barrier layer has a thickness of 0.1 to 10 mm. Preferably, the thickness of the barrier layer can be in a range between 0.1 and 3 mm.

The total thickness of the protective element is preferably 0.2 to 20 mm, more preferably 0.4 to 8 mm. The area of the protective element is preferably 30% to 100%, more preferably 60% to 95% of the area of a flat outer surface of a battery cell.

According to the invention the barrier layer is stiff, which means that it is more rigid than the buffer layer so that the barrier layer is not compressed or less compressed compared to the buffer layer in the course of the dimensional changes of the battery cells. In a preferred embodiment the barrier layer can have a compression force of at least 150% of that of a buffer layer at the same deflection. For example, if the buffer layer shows 0.1 MPa of compression force at 0.1 mm deformation, the barrier layer should have a value of at least 0.15 MPa at the same deformation. If the value of the barrier layer is too low, it can be deformed permanently, which may lead to loss of its original purpose to block the heat transfer.

Furthermore, the barrier layer is preferably designed in such a way that it does not melt even if exposed to high temperatures of at least 600° C. over a period of two minutes, particularly preferably at least 1000° C. preferably over a period of two minutes. In this way, it acts as a barrier to other battery cells in the event of thermal runaway of a battery cell.

The dielectric strength of the barrier layer and/or the buffer layer can have a value of more than 2.5 kV/mm. Preferably, this value can be higher than 3.5 kV/mm.

The buffer layer and barrier layer can be assembled into the protective element of the invention by various processes, such as lamination, dispensing, spraying, flat streaming, slot coating and roll-to-roll.

According to the invention, it can be provided that a layer of an adhesive material is arranged between the buffer layer and the barrier layer. The adhesive material may comprise, for example, pressure sensitive adhesive or hotmelt.

The outer surfaces of the protective element may in principle be formed by a buffer layer and/or a barrier layer. According to an alternative embodiment of the invention, at least one outer surface of the protective element comprises a film based on polyethylene terephthalate, polyethylene, polypropylene, polyolefine, nylon, polyamideimide, polyamide or polyimide. It may be provided that the film is bonded to the buffer layer and/or the barrier layer by an adhesive material.

In a further embodiment of the invention, the barrier layer may comprise hollow particles, for example in the form of hollow silica and/or an aerogel, for improved thermal insulation.

In a further embodiment of the invention in order to reinforce the heat insulation properties, a refractory insulating material can be embedded in the buffering layer and/or the barrier layer. The refractory insulating material can be selected from one of micro silica, silica aerogel, glass bubble, some micro- and/or nano-sized particles with spaces for trapping air.

According to another embodiment, the invention further relates to a battery assembly having at least two battery cells between which a multilayer protective element is arranged, as disclosed and claimed herein. In the case of a battery assembly having a plurality of battery cells, it may in principle be provided that a protective element according to the invention is arranged between every two adjacent battery cells. Alternatively, it may be provided that such a protective element is provided only between some of the battery cells.

In addition, according to another embodiment, the use of a multilayer protective element according to the invention described and claimed herein, as well as methods thereof, are proposed for interposing between two battery cells in a battery assembly.

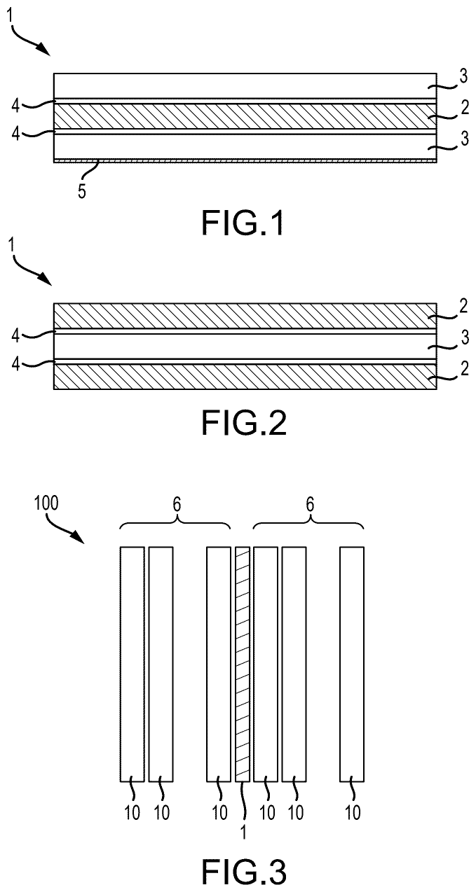

FIG. 1 shows a multilayer protective element according to the invention, designated in its entirety as 1. The protective element 1 comprises a central elastic buffer layer 2, which is made of non-woven felt of partially oxidized polyacrylonitrle fiber. A stiff heat insulating barrier layer 3 comprising a ceramic material, in this case mica, is disposed on each side of the buffer layer 2. The buffer layer 2 is bonded to each of the two barrier layers 3 via a thin layer 4 of an adhesive material. In this case, the adhesive material is a pressure sensitive adhesive.

An outer surface of the protective element 1 is formed by a film 5 based on polyethylene terephthalate, which serves to protect the underlying barrier layer 2. Also, the film 5 and the underlying barrier layer 2 are bonded together by a layer of an adhesive material not shown in the figure.

The buffer layer 2 has a thickness of 4 mm and the barrier layers 3 has a thickness of 1 mm. The entire protective element 1, including the adhesive layers 4, has a thickness of about 8 mm.

The protective element 1 thus combines in one component a buffer layer 2, which is elastic and thus reversibly compressible, and two stiff barrier layers 3, which have fire-retardant and heat insulating properties due to their material. This makes the protective element 1 eminently suitable for interposing between battery cells 10 in a battery assembly 100, as shown in FIG. 3.

FIG. 3 shows a battery assembly designated 100 in its entirety, in which stacks 6 of prismatic battery cells 10 are arranged next to each other. Each stack 6 comprises several, for example eight, battery cells 10, of which, however, only 3 are shown in FIG. 3. As schematically indicated in FIG. 3, the battery assembly 100 comprises a plurality, for example 10, of such stacks 6 of battery cells 6. A multilayer protective element 1 having the above-described properties is arranged between each two stacks 6. In principle, it is possible to provide such a protective element 1 between every two adjacent battery cells 10; however, this is accompanied by increased cost and space requirements. In this respect, it is a good compromise to provide protective elements 1 between the stacks 6.

FIG. 2 shows a further embodiment of a multilayer protective element designated in its entirety as 1. The protective element 1 has a central barrier layer 3 comprising a ceramic material, in this case glass fiber. For even better heat insulation, the barrier layer 3 further comprises aerogel particles. A buffer layer 2 made of non-woven felt of partially oxidized polyacrylonitrile fiber is arranged on each side of the central barrier layer 3. The barrier layer 3 and the buffer layers 2 are bonded together by adhesive layers 4.

The two buffer layers 2 each form an outer surface of the protective element 1. Unlike the embodiment example of FIG. 1, no additional film is provided on the outer surface here.

The total thickness of the protective element 1 is about 8 mm, with each of the buffer layers 2 having a thickness of about 2.5 mm and the barrier layer 3 having a thickness of about 3 mm.

### LIST OF REFERENCE NUMBERS IN FIGURES

1 protective element
2 buffer layer
3 barrier layer
4 layer
5 film
6 stack
10 battery cell
100 battery assembly

What is claimed is:

1. A multilayer protective element for a battery assembly having at least two battery cells, wherein the protective element can be arranged between the battery cells, wherein the protective element comprises at least two heat resistant layers:
a. a first layer is formed as an elastic buffer layer and comprises a non-woven polymeric material and/or a non-woven ceramic material; and
b. a second layer is formed as a stiff heat insulating barrier layer and comprises a ceramic material.

2. The multilayer protective element according to claim 1, wherein the polymeric material is present in the first layer and is selected from non-woven fiber comprising partially and fully oxidized polyacrylonitrile, silicate, silica, metal oxide, metal nitride, metal carbide, metal carbonate, mica, rock powder, glass fiber and combinations thereof comprising one or more of these materials.

3. A multilayer protective element according to claim 1, wherein the ceramic material of the buffer layer and/or of the barrier layer is selected from materials comprising silicate, silica, metal oxide, metal nitride, metal carbide, metal carbonate, mica, rock powder, glass fiber, and combinations thereof comprising one or more of these materials.

4. The multilayer protective element according to claim 3, wherein the buffer layer has a thickness of 0.1 to 10 mm.

5. The multilayer protective element according to claim 4, wherein the barrier layer has a thickness of 0.1 to 10 mm.

6. The multilayer protective element according to claim 5, wherein the total thickness of the protective element is 0.2 to 20 mm.

7. The multilayer protective element according to claim 6, wherein a layer of an adhesive material is arranged between the buffer layer and the barrier layer.

8. The multilayer protective element according to claim 7, wherein at least one outer surface of the protective element comprises a film based on polyethylene terephthalate, polyethylene, polypropylene, polyolefine, nylon, polyamideimide, polyamide or polyimide.

9. The multilayer protective element according to claim 8, wherein the film is bonded to the buffer layer and/or the barrier layer by an adhesive material.

10. The multilayer protective element according to claim 9, wherein the barrier layer comprises hollow silica and/or an aerogel.

11. The multilayer protective element according to claim 10, wherein compression force of the buffer layer at 25% compression of said buffer layer is about 5 to 300 kPa, and compression set is less than 10%, based on standard specification ASTM D1056 at a temperature of about 100° C.

12. The multilayer protective element according to claim 11, wherein the buffer layer and/or the barrier layer has a thermal conductivity of less than 0.5 W/mK, in a direction perpendicular to a surface area facing a battery cell.

13. The multilayer protective element according to claim 12, wherein a refractory insulating material is embedded in the buffering layer and/or the barrier layer.

14. A battery assembly comprising:
a. a plurality of battery cells; and
b. a multilayer protective element according to claim 1 arranged between at least some of said plurality of battery cells.

15. The battery assembly of claim 14 wherein the plurality of battery cells is arranged in multiple adjacent stacks in the battery assembly and the multilayer protective element is interposed between at least some adjacent stacks.

16. A method of dynamically compensating for dimensional changes of battery cells in a battery assembly and/or protecting against heat propagation of the battery assembly comprising interposing multilayer protective elements according to claim 1 between at least some of the battery cells in the battery assembly.

17. The method of claim 16 comprising interposing multilayer protective elements between every adjacent battery cell.

18. The method of claim 16, wherein the battery cells are arranged in multiple adjacent stacks in the battery assembly, the method comprising interposing multilayer protective elements between at least some adjacent stacks in the battery assembly.
